(19) United States
(12) Patent Application Publication
(10) Pub. No.: US 2008/0257416 A1
(43) Pub. Date: Oct. 23, 2008

(54) Connector with screw valve

(76) Inventors: Scott Noble Hickman, Ventura, CA (US); Gu Xiuming, Guangzhou (CN)

Correspondence Address: DLA PIPER US LLP, 2000 UNIVERSITY AVENUE, E. PALO ALTO, CA, 94303-2248, US

(21) Appl. No.: 11/787,480

(22) Filed: Apr. 17, 2007

(51) Int. Cl. F16L 29/00; B60C 29/04; F16L 29/02; F16L 29/04

(52) U.S. Cl. 137/223; 137/614.05; 251/149.1; 251/149.6

(57) ABSTRACT

A connector with a screw valve is described that attaches to the end of the outlet tube, remains closed unless it is completely screwed onto a tire valve and then opens when it is screwed directly onto a valve, such as a tire valve.

### FIELD OF THE INVENTION

This invention relates to a fluid and/or air dispensing device in which a valve can be used to control whether gas or liquid are allowed to exit from the device.

### BACKGROUND OF THE INVENTION

Several designs exist for injecting air and liquid into a object, such as a tire, through a valve, such as a tire valve. For example, sealant fluid may be injected with pressurized air into a tire to seal and repair the tire. Most designs pressurize a sealant container which forces the sealant fluid through an outlet tube. Commonly, a connector is attached between the outlet tube and a valve of the item being repaired and inflated using the device. In more devices, fluid and/or air is forced through the valve under pressure so that the tire, when inflated, is pressurized above atmospheric pressure. The sealant container is also pressurized to above atmospheric pressure. When the device is disconnected from the tire valve, the pressure equalizes and usually fluid sprays from the connector which is undesirable.

At other times, a user may improperly connect or even neglect to connect the tire valve before pressurizing the sealant container which results in sealant spraying onto the user, the tire, the vehicle, and the ground which is also very undesirable. No existing device currently provides a solution to this problem. Thus, it is desirable to provide a screw valve that overcomes these problems and it is to this end that the present invention is directed.

### SUMMARY OF THE INVENTION

A screw valve is provided that is a connector that attaches to the end of the outlet tube. The screw valve remains closed unless it is completely screwed into a valve of the item and then, once properly screwed into the valve of the item, the screw valve opens. In an exemplary embodiment, the screw valve may be used for a sealant system that is used to repair and inflate a tire, such as a automobile tire, where the screw valve prevents a user from getting sprayed with sealant fluid if the user improperly connects or neglects to connect the sealant outlet hose connector to the tire valve. Once the screw valve on the sealant system is properly connected to the tire valve, the screw valve opens and permits the air and/or sealant fluid to flow into the tire.

### BRIEF DESCRIPTION OF THE DRAWINGS

FIG. 1 illustrates a first embodiment of a connector with a screw valve on the end of a hose;

FIG. 2 illustrates more details of the connector shown in FIG. 1;

FIG. 3 is a side cross-sectional view of the connector shown in FIG. 2 when the connector is closed;

FIG. 4 shows the connector of FIGS. 1-3 when the connector is open;

FIG. 5 is a side cross sectional view of the connector shown in FIG. 4;

FIG. 6 illustrates another embodiment of the connector with a screw valve; and

FIGS. 7A and 7B are side cross sectional views of the connector of FIG. 6 showing the connector in the open and closed positions, respectively.

### DETAILED DESCRIPTION OF EXEMPLARY EMBODIMENTS

The screw valve is particularly applicable to a sealant system with sealant fluid and a compressed air source that is used to repair and/or inflate a tire, such as an automobile tire, by injecting sealant fluid and/or air/compressed air into the tire and it is in this context that the screw valve will be described. It will be appreciated, however, that the screw valve can be used in any system/device/mechanism in which it is desirable to keep a fluid and/or a gas from exiting the system/device/mechanism until a connector is properly seated.

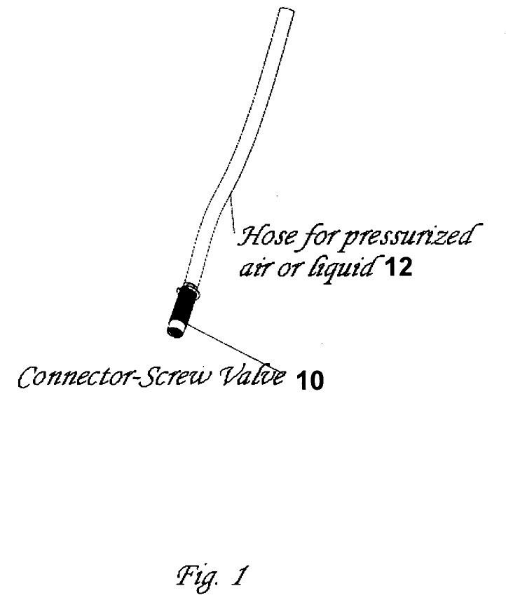

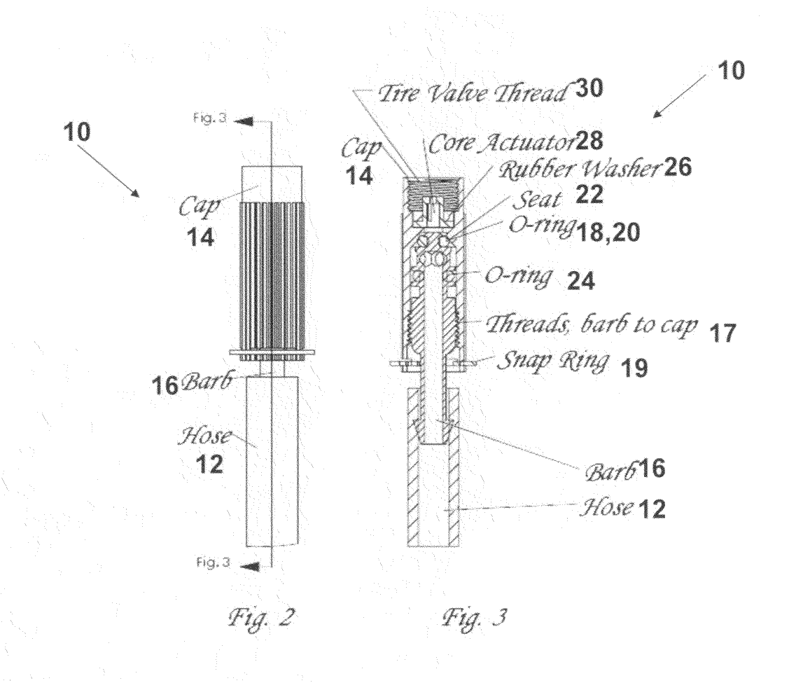

FIG. 1 illustrates a first embodiment of a connector 10 with a screw valve on the end of a hose 12 wherein the hose may be used to transmit pressurized air and/or liquid from a sealant container into a tire. In this figure, the hose is not yet connected to the tire valve. FIG. 2 illustrates more details of the connector 10 shown in FIG. 1 wherein the connector further comprises a cap 14 and a barb 16. FIG. 3 shows a cross-sectional view of FIG. 2 wherein the barb 16 is screwed into the cap 14 using a set of threads 17. The cap 14 may further include one more sealing elements 18, 20, such as known O-rings in an exemplary embodiment, that seal the connector 10 and prevent the fluid and/or air in the hose 12 (when connected to a fluid and/or gas source) from exiting the connector 10 via the threads 17. The connector 10 may also have a connecting mechanism 19, such as a snap ring or crimp, that releasably or permanently connects the barb 16 to the connector 10. The cap 14 may have a seat 22 in which an upper portion of the barb 16 seats when the barb is coupled to the connector 10. The barb 16 may also have a sealing element 24, such as a known O-ring. An upper portion of the cap 14 may further comprise a sealing element 26, such as a rubber washer, a core actuator 28 and a set of threads 30 wherein a tire valve is screwed into the set of threads so that the front of the tire valve rests against the sealing element 26 to seal the connecting between the tire valve and the connector and the core actuator 28 opens the valve in the connector 10 when the connector 10 is properly seated with the tire valve. This ensures that the liquid and/or fluid in a container attached to the hose 12 does not exit the connector 10 until the tire valve and the connector are properly seated.

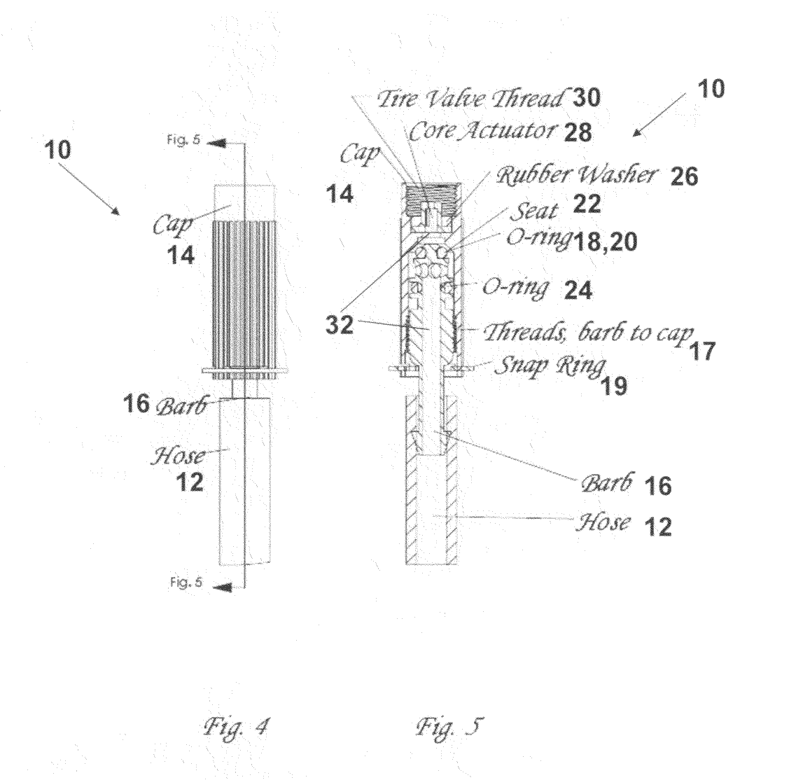

FIG. 4 shows the connector of FIGS. 1-3 when the connector is open and FIG. 5 is a side cross sectional view of the connector shown in FIG. 4 when the connector is screwed onto a tire valve so that the screw valve is open when the cap 14 has been screwed upward separating the barb o-ring 18, 20 from the seat 22. When the connector 10 is not attached to a tire, the barb o-ring 18, 20 is pressed against the cap seat 22 that prevents any liquid and/or gas from passing out from the hose through the connector. When the connector is screwed onto a tire, the cap seat 22 moves away from the barb o-ring 18, 20 allowing gas or liquid to pass out through the connector and into the tire. A flow 32 of fluid/air from the hose through the barb 16, connector 10 and core actuator 28 (a conduit) when the connector is open is shown the arrows in FIG. 5.

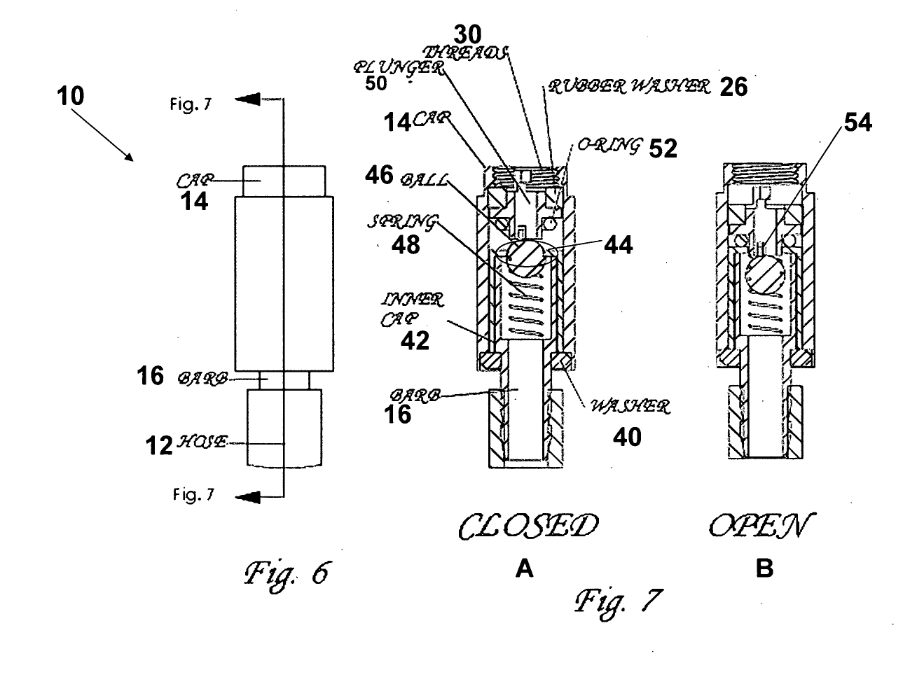

FIG. 6 illustrates another embodiment of the connector 10 with the screw valve and FIGS. 7A and 7B are side cross sectional views of the connector of FIG. 6 showing the connector in the open and closed positions, respectively. The connector 10 in this embodiment has a sealing mechanism 40, such as a washer, that seals the connection between the connector and the barb to prevents leaks. The cap 14 may further include an inner cap 42 that has an upper opening 44 and also has a sealing device 46, such as a rubber ball, and a bias member 48, such as a spring within a cylindrical portion of the barb. The cap has the set of threads 30 that permit the user to thread a tire valve onto the connector. The connector 10 also has a plunger 50 that is freely contained inside the cap, but it is able to move axially inside the cap. The sealing mechanism 26, such as a rubber washer, is against the tire valve side of the plunger and seals the assembly when attached to the tire valve. The connector 10 may also have a sealing device 52, such as an O-ring, that is on the lower flange side of the plunger 50 as shown. The sealing device 46 is pushing against the plunger 50 and is contained inside an inner cap. The inner cap 42 is press-fit over a cylindrical extension of the barb 16.

The spring 48 and rubber ball 46 form a simple check valve with the barb 16 and inner cap 42. The washer 40 is press-fit onto both the barb and the cap to hold the assembly together. Alternatively, the cap can be crimped around the washer. In the closed position (when the connector is not attached to a tire) as shown in FIG. 7A, the sealing device 46 is pressed against the upper opening 44 of the inner cap 42 and seals the connector to prevent gas and/or liquid from passing from the hose through the connector. In the open position (when the connector is screwed onto a tire valve) as shown in FIG. 7B, the tire valve presses against the sealing device 26 that pushes the plunger 50 towards the rubber ball. The plunger 50 in turn pushes the rubber ball 46 away from the inner cap opening 44 and an opening 54 in the plunger 50 is below the opening 44 (shown in FIG. 7B) which forms a conduit and allows gas and/or liquid to pass from the hose through the connector and into a tire valve.

While the foregoing has been with reference to a particular embodiment of the invention, it will be appreciated by those skilled in the art that changes in this embodiment may be made without departing from the principles and spirit of the invention, the scope of which is defined by the appended claims.

1. A connector with a screw valve, comprising:
a hose connection mechanism; and
a connector coupled to the hose connection mechanism and capable of receiving a valve of an item, the connector further comprising a screw valve mechanism that seals the connector unless the valve of the item is properly seated to the connector.

2. The connector of claim 1, wherein the hose connection mechanism connects to a source of a gas wherein the gas, when the connector is open, flow into the item through the valve to inflate the item.

3. The connector of claim 1, wherein the hose connection mechanism connects to a source of fluid wherein the fluid, when the connector is open, flow into the item through the valve to repair the item.

4. The connector of 3, wherein the fluid further comprises a sealant fluid.

5. The connector of claim 1, wherein the screw valve mechanism further comprises a set of threads, a core actuator, a sealing mechanism and a seat wherein the core actuator is moved away from the seat when the valve of the item is screwed into the set of threads to open the connector and forms a conduit between the hose connection mechanism and the connector.

6. The connector of claim 1, wherein the screw valve mechanism further comprises a set of threads, a plunger located within the connector, an inner cap, within the connector, having an opening within the inner cap, and a sealing device that is biased against the opening within the inner cap when the connector is in a closed position wherein the plunger presses against the sealing device when the valve of the item is screwed into the set of threads and move the sealing device away from the opening and forms a conduit between the hose connection mechanism and the connector.

7. The connector of claim 6, wherein the sealing device further comprises a ball and a spring that biases the ball against the opening of the inner cap when the connector is in a closed position.

8. The connector of claim 1, wherein the item further comprises a tire and the valve further comprises a tire valve.
